(19) United States
(12) Patent Application Publication
(10) Pub. No.: US 2020/0355115 A1
(43) Pub. Date: Nov. 12, 2020

(54) INTERNAL COMBUSTION ENGINE WITH OPPOSED PISTONS AND A CENTRAL DRIVE SHAFT

(71) Applicant: Luis CARRILLO LOSTAO, London (GB)

(72) Inventor: Luis CARRILLO LOSTAO, London (GB)

(21) Appl. No.: 16/762,192

(22) PCT Filed: Nov. 8, 2018
(86) PCT No.: PCT/ES2018/070721

§ 371 Date: May 7, 2020

(30) Foreign Application Priority Data
Nov. 9, 2017 (ES) P201731310

(51) Int. Cl. F02B 75/28; F02M 35/104; F01N 13/10

(52) U.S. Cl. CPC F02B 75/28; F01N 13/10; F02M 35/104

(57) ABSTRACT

The present invention provides an internal combustion engine that comprises at least one axial geometric cylinder axis and one axial geometric central axis, both geometric axes being orthogonal to one another; a first cylinder coaxial to the cylinder axis; a second cylinder coaxial to the cylinder axis provided opposite the first cylinder; a central body comprising a hole that is axially aligned with the central shaft, a first cylindrical recess and a second cylindrical recess configured to couple the second cylinder; a central drive shaft arranged in the hole of the central body; a first piston provided in the first cylinder, said first piston being connected to the central drive shaft by means of a first pair of connecting rods; and a second piston provided in the second cylinder opposite the first piston, said second piston being connected to the central drive shaft by means of a second pair of connecting rods.

### TECHNICAL FIELD OF THE INVENTION

The present invention is related to internal combustion engines, particularly to internal combustion engines that have opposed cylinders, each cylinder having a piston, wherein the pistons, in the operation thereof, move symmetrically with respect to a common reference point or reference axis.

### STATE OF THE ART

Opposed-piston engines, known as OP engines, are thermal machines with a high energy density. Opposed-piston (OP) engines and opposed-piston opposed-cylinder (OPOC) engines can be engines in which the piston stroke is very long. Therefore, obtaining the power required for large applications is more complicated than simply increasing the diameter of the piston and the stroke to obtain the necessary motion. Moreover, increasing said diameter and piston stroke increases the size and weight of the motor, as well as the inertia and the unbalancing associated with the same.

To respond to the need to increase the energy density in OP and OPOC engines, different solutions have been proposed, as will be seen below.

Document GB 1020150 is known, which describes an opposed cylinder reciprocating internal combustion engine comprising a first reciprocating piston inside a first cylinder that has a first cylinder head, a second reciprocating cylinder inside a second cylinder opposite the first cylinder and which has a second cylinder head, a common camshaft located between and adjacent to the two cylinder heads that operates to control an inlet of a mixture of air and fuel and an outlet for exhaust gases in each cylinder head and a connecting rod that extends from each piston, such that the reciprocal motion of each piston is converted to rotational motion of the crankshaft. The common characteristics of this document form part of the preamble of the independent claim.

Also known is document GB 531009, which describes an engine with at least two opposed pistons in each cylinder, each pair of pistons being closer to the crankshaft of the engine and connected to the same by means of connecting rods that function on a bolt of a common connecting rod, and the pair of outer pistons which have a stroke that is equal to or less than the stroke of the inner pistons and which are controlled by a mechanism that operatively connects the outer pistons to the crankshaft of the engine. The combustion chamber of each cylinder is formed in a known way by the space between the two pistons in each cylinder. The control mechanism by which the outer pistons are operatively connected to the crankshaft of the engine can comprise braces that connect the pair of outer pistons and are operated or controlled by a pair of eccentric shafts or crankshafts arranged on opposite sides of the crankshaft of the common crankshaft.

U.S. Pat. No. 8,757,123B2 by Ecomotors INC. proposes an OPOC type engine wherein the pistons are symmetrically arranged, or put differently, with inner exhaust pistons and outer intake pistons. This arrangement facilitates the arrangement of short exhaust pipes into a turbocharger. Furthermore the intake pistons can be identical, the exhaust pistons can be identical and the right and left cylinders can be identical to reduce the number of unique parts in the engine and reduce the engineering design and verification effort. However, one disadvantage of the configuration of the piston, which is shown in FIG. 3, is that the balance is slightly disturbed. The resulting imbalance in the configuration of the engine in FIG. 3 is small compared to a conventional in-line engine.

As can be seen in this prior art document, an imbalance is created due to the location where combustion is carried out, and furthermore, although the document mentions that the number of unique parts is reduced, the engine is complex and difficult to build. Moreover, increasing the power density would consist of increasing the size of the pistons and the stroke thereof, and as a result, would increase the overall size of the engine.

Furthermore, U.S. Pat. No. 6,170,443 by Peter Hofbauer describes a two-stroke internal combustion engine that has opposed cylinders, each cylinder having a pair of opposed pistons, with all of the pistons connected to a common central crankshaft. The inboard pistons of each cylinder are connected to the crankshaft by pushrods and the outboard pistons are connected to the crankshaft by pullrods. This configuration results in a compact engine with a very low profile, in which the free mass forces can be essentially totally balanced. The engine configuration also allows for asymmetrical timing of the intake and exhaust ports through independent angular positioning of the eccentrics on the crankshaft, making the engine suitable for supercharging.

In spite of the advantages obtained with the Hofbauer engine, there is a large number of components and the engine is difficult to build.

Likewise, U.S. Pat. No. 3,000,366 by Walter L. Blackburn discloses an opposed-piston type engine in which the block or cylinder head remains stationary, but wherein valve means are provided for opening and closing the intake and exhaust holes in combination with the piston, such that the holes quickly open and close. This way, advantageously, a very fast opening and closing of the intake and exhaust holes is achieved and it is not necessary to reciprocate the cylinder or other means for controlling the opening and closing of these movements, such that the cylinder cools as a stationary unit, avoiding the inherent drawbacks of moving the cylinder elements and the members associated with one another with heat differentials.

According to the previously mentioned points, it is clear that there is a need to provide a self-balancing opposed-piston (OP) engine, in which there is an increase in the power density compared to engines of the same size, but in which there is less complexity in the parts, facilitating production and reducing costs.

### DESCRIPTION

In order to overcome the drawbacks and solve the problems found in the state of the art, the present invention provides an internal combustion engine that comprises at least one axial geometric cylinder axis and one axial geometric central axis, both geometric axes being orthogonal to one another; a first cylinder coaxial to the cylinder axis; a second cylinder coaxial to the cylinder axis provided opposite the first cylinder; a central body comprising a hole that is axially aligned with the central shaft, a first cylindrical recess and a second cylindrical recess configured to couple the second cylinder; a central drive shaft arranged in the hole of the central body; a first piston provided in the first cylinder, said first piston connected to the central drive shaft by means of a first pair of connecting rods; and a second piston provided in the second cylinder opposite the first piston, said second piston being connected to the central drive shaft by means of a second pair of connecting rods.

In alternative embodiments of the invention, in the internal combustion engine each one of the connecting rods of the first pair of connecting rods and of the second pair of connecting rods comprises eccentric mechanisms that rotationally connect said first pair of connecting rods and second pair of connecting rods to the central drive shaft, wherein said eccentric mechanisms are configured to convert the linear motion of the first piston and the second piston into circular motion in the central drive shaft

In other alternative embodiments of the internal combustion engine the central drive shaft comprises at least a smooth cylindrical portion configured to be in the hole of the central body, and at least two connecting portions configured to connect to the eccentric mechanisms and to receive torque from said eccentric mechanisms.

Preferably, the central body of the internal combustion motor additionally comprises an intake channel that extends in a direction parallel to the axial cylinder axis and which passes through the central body, an exhaust channel that extends in a direction parallel to the axial cylinder axis and which passes through the central body, an intake port in fluid connection with the intake channel, an exhaust port in fluid connection with the exhaust channel.

In other embodiments of the invention the internal combustion engine comprises at least one intake manifold pipe in connection with the intake port of the central body, at least one exhaust manifold pipe in connection with the exhaust port of the central body, at least one intake valve operatively linked to the intake port and configured to control the intake of gases from the intake manifold pipe to the intake port, and at least one exhaust valve operatively linked to the exhaust port and configured to control the release of gases from the exhaust port to the exhaust manifold pipe.

In other alternative embodiments the internal combustion engine comprises a support cage configured to support the internal combustion engine as a whole based on the fastening of the first cylinder and the second cylinder.

One advantaged achieved from the present invention is that the central body, which could be called cylinder head, is shared by the two pistons, and therefore the channels arranged in the same are likewise shared, and therefore the number of parts of the engine is reduced and the engine is simplified, making the same more economic and easier to produce.

Another advantage obtained from the engine of the present invention is related to the intake and exhaust valves which, given that they are not mounted on the cylinder, can be larger, which facilitates the intake of air and/or the mixture of air and fuel and the exhaust of the combustion gases, improving the efficiency of the combustion cycle.

Another noteworthy advantage of the invention is achieved in the transformation of reciprocating linear motion into circular motion in the central drive shaft. Given that the linear motion of the pistons is transmitted to the central drive shaft by the eccentric mechanism arranged on the connecting rods, said central drive shaft only receives the rotational torque from the eccentric mechanism and therefore is not subjected to the reciprocating forces to which crankshafts are commonly subjected, which allows the size of said shaft to be reduced, reducing the weight of the engine and the size thereof, and making the motor more inherently balanced.

One notable advantage of the engine of the invention is the capacity it has to be able to use different fuels, as well as the changes in the functioning of the thermal cycle, in other words, functioning at two strokes or four strokes, making minimal structural variations to said engine, particularly in the central body and to the elements linked to the same, which makes the engine into a versatile engine, easily adaptable to any particular situation.

Another one of the advantages obtained by the present invention is related to the stroke/diameter relationship of the piston. The engine claimed has a generally square or super-square configuration. Given that the pistons work in the same stroke of the thermal cycle, the total stroke per cycle is the sum of the strokes of each one of the pistons, and therefore the power density of the engine is improved, since by having a longer combined stroke per cycle the output torque is increased.

### BRIEF DESCRIPTION OF THE FIGURES

The previous advantages and characteristics, in addition to others, shall be understood more fully in light of the following detailed description of exemplary embodiments, with reference to the drawings attached, which must be understood by way of illustration and not limitation, wherein:

FIG. 1 is a perspective view of the internal combustion engine of the present invention, which includes at least two pistons.

FIG. 2 is a perspective view of the central body of the internal combustion engine of the present invention, which includes at least two pistons.

FIG. 3 is a cross-sectional view of the internal combustion engine of the present invention.

FIG. 4 is a perspective view of one of the pistons of the internal combustion engine of the present invention.

FIG. 5 is a perspective view showing the central drive shaft with one of the connecting rods.

FIG. 6 is a view of a particular embodiment of the combustion engine with four central bodies, eight cylinders and eight pistons.

### DETAILED DESCRIPTION OF AN EXEMPLARY EMBODIMENT

The following detailed description presents a number of specific details by way of example to provide a detailed understanding of the relevant teachings. However, it is clear for a person skilled in the art that the present teachings can be carried out without these details.

To simplify the description, several of the elements and subsystems of the combustion engine have been omitted. As such, only the elements of the engine that are necessary for viewing the novel technical elements and facilitating the comprehension of the technical effects achieved by means of the same are illustrated. Obviously, other conventional parts of the internal combustion engine are used to provide a complete engine. Given that these parts are conventional, the description thereof is not considered necessary.

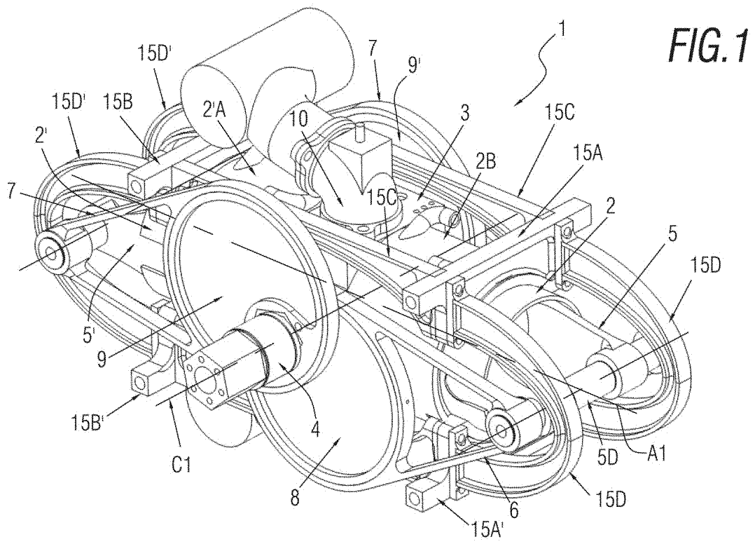

According to a preferred embodiment, and as can be seen in FIG. 1, the present invention provides an internal combustion engine (1) of the type with facing opposed pistons with respect to a central body (3).

As can be seen in FIG. 1, defined in the internal combustion engine (1) are at least one axial geometric cylinder axis (A1) and an axial geometric central axis (C1), said geometric axes being orthogonal to one another. As will be shown further on, the axial geometric cylinder axis (A1) has been defined to demonstrate that the axial axis of the first cylinder (2) and the axial axis of the second cylinder (2′) are coaxially aligned with one another in relation to said axis (A1), and as a result, the first piston (5) and the second piston (5′), in the reciprocating motion thereof, move linearly in the direction of said axial geometric cylinder axis (A1). Therefore, the internal combustion engine (1) of the present invention is configured to be coupled in pairs of cylinders and pistons with respect to a central body. This being so, and to simplify the explanation, the internal combustion engine (1) illustrated in FIG. 1 comprises a pair of cylinders and pistons aligned with respect to the axial geometric cylinder axis (A1), however, in other preferred embodiments there may be two or more pairs of cylinders and pistons aligned with respect to the corresponding axes thereof (A2), (A3), (A4), etc., according to the requirements of the engine for each specific application.

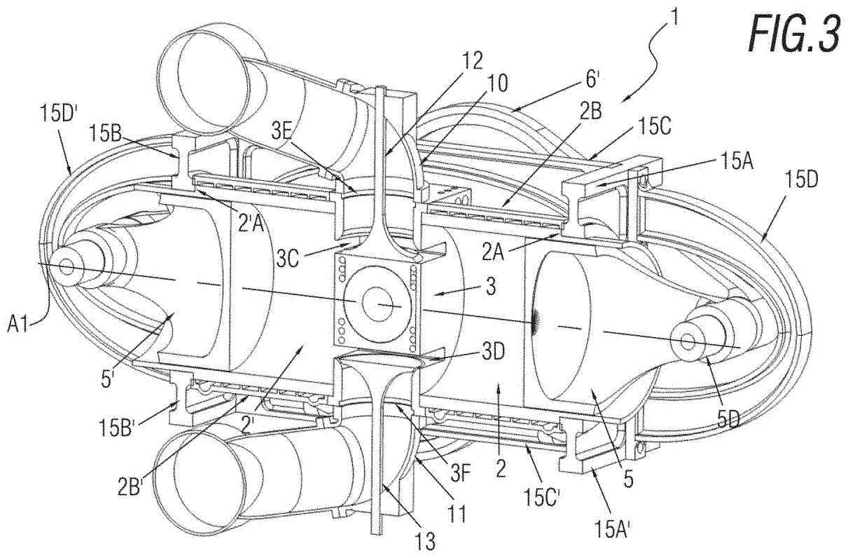

As was previously stated, the internal combustion engine (1) comprises at least a first cylinder (2) coaxial to the cylinder axis (A1), and at least a second cylinder (2′) coaxial to the cylinder axis (A1) provided opposite and in a direction facing the first cylinder (2). Given that the first cylinder (2) and the second cylinder (2′) are essentially equal in the construction thereof, only the first cylinder (2) will be described, understanding that the same characteristics are present in the second cylinder (2′). As can be seen in FIG. 3, the first cylinder (2) has a protrusion (2A) on the outer surface thereof configured to receive a section of the support cage (15), which butts against the same. As will be described further on, the internal combustion engine (1) as a whole is sustained by means of a support cage (14), wherein said support cage holds the cylinders and secures them to the central body (3)

In preferred embodiments, and as can be seen in FIGS. 1 and 3, a first complementary cylinder (2B) is arranged, in which the first cylinder (2) is inserted, and a second complementary cylinder (2′B) is arranged, in which the second cylinder (2′) is inserted. The main function of said complementary cylinders (2B) (2′B) is to remove heat generated by combustion and couple additional elements for the normal functioning of the engine.

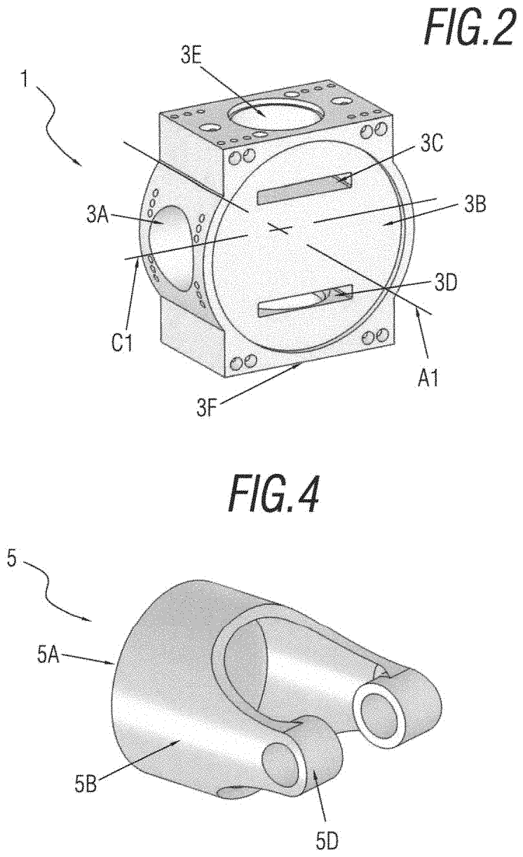

As can be seen in FIG. 1, and in greater detail in FIG. 2, the internal combustion engine comprises a central body (3), wherein a first cylindrical recess (3B) is defined, configured to couple the first cylinder (2), and a second cylindrical recess (3B′) is defined, configured to couple the second cylinder (2′). For properly coupling the cylinders (2) (2′), these recesses (3B) (3B′) preferably have a cylindrical form, the axial axis of which is coaxial to the axial geometric cylinder axis (A1). Therefore, as can be seen in FIG. 1, the central body (3) is shared by the first (2) and second (2′) cylinders. On the other hand and according to FIG. 2, the central body (3) additionally comprises an intake channel (3C) that extends in a direction parallel to the axial cylinder axis (A1) and which passes through the central body (3), an exhaust channel (3D) that extends in a direction parallel to the axial cylinder axis (A1) and which passes through the central body (3). It was previously mentioned that the combustion engine (1) of the present invention has the capacity to be able to use different fuels, and to be able to make changes in the functioning of the thermal cycle, in other words, functioning at two strokes or four strokes, making minimal structural variations in said engine. This advantage is mainly obtained from the central body (3) for the reasons described below. Given that the intake (3C) and exhaust channels (3D) pass through the central body (3), the first cylinder (2) and the second cylinder (2′) are in fluid communication by means of said channels (3C) (3D) and therefore compression is done in the aforementioned channels (3C) (3D), as can be seen in FIG. 3, and not between the cylinder head and the piston, as is done in conventional combustion engines. Thus, the compression ratio is controlled by the shape and size of the channels, which is suitable to be able to adapt to the fuel used. The central body also comprises an intake port (3E) in fluid connection with the intake channel (3C), an exhaust port (3F) in fluid connection with the exhaust channel (3D), wherein the entry of gases, such as air or a mixture of air and fuel, through the intake port (3E) is regulated by means of at least one intake valve (12), operatively linked to said intake port (3E), and the release of gases which are the product of combustion is regulated by means of an exhaust valve (13), operatively linked to said intake port (3E). Given that the intake (3E) and exhaust ports (3F) are not limited by the size of the cylinders (2) (2′), it is possible to vary the size of the same, as well has to have a different number and different configurations of valves for the intake and/or exhaust of gases. The particular arrangement of the central body (3) also allows injectors, turbos, to be incorporated as a function of the type of fuel and power and torque requirements of the engine. A person skilled in the art knows that such elements can be included and are within the scope of the invention.

The central body (3) also comprises a hole (3A) that passes through said central body (3A) and which is axially aligned with the axial geometric central axis (C1). The hole (3A) is provided to house a central drive shaft (4). Given that the central body (3) is shared by the first (2) and second cylinders (2′) each one of which is facing a side of the central body (3), the same is situated in a central part of the engine (1), and as a result the central drive shaft (4) is arranged in the center of the engine (1), which represents technical advantages that will be analyzed further on.

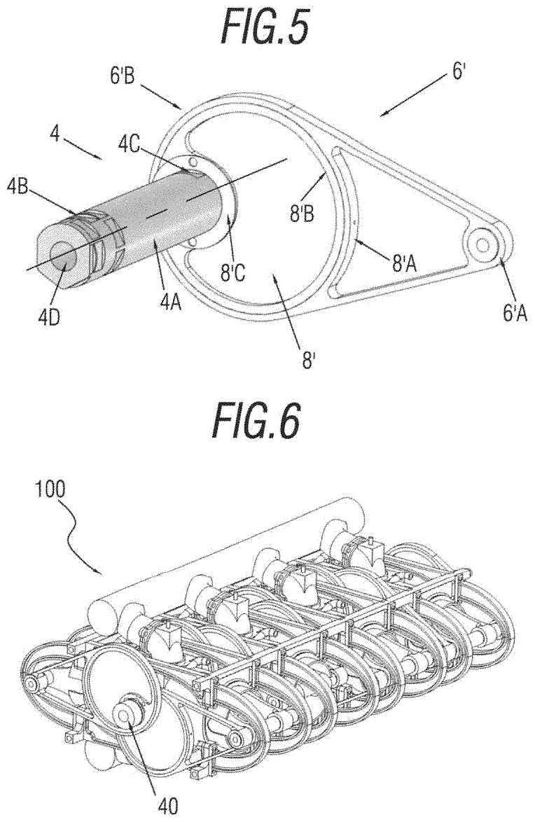

As was previously mentioned, the central drive shaft (4) is arranged in the hole (3A) of the central body (3) and comprises at least a smooth cylindrical portion (4A) and at least connecting portions (4B) (4C), as can be seen in FIG. 5. The smooth cylindrical portion (4A) is that which runs through the hole (3A) of the central body (3), while the connecting portions are outside the central body (3) and are configured to connect to eccentric mechanisms (8) (8′) (9) (9′) arranged on a first pair of connecting rods (6) (6′) and on a second pair of connecting rods (7) (7′) and to receive torque from said eccentric mechanisms (8) (8′) (9) (9′). The eccentric mechanisms (8) (8′) (9) (9′) and the interaction thereof with the connecting portions (4B) (4C) are explained in detail below. In alternative embodiments, the central drive shaft (4) has a central passage (4D) which is configured to distribute lubricant to the components connected to the same, as well as to reduce weight.

On the other hand, and according to FIGS. 1 and 3, the internal combustion engine (1) comprises a first piston (5) provided in the first cylinder (2), said first piston (5) being connected to the central drive shaft (4) by means of a first pair of connecting rods (6) (6′); and a second piston (5′) provided in the second cylinder (2′) opposite the first piston (5), said second piston (5′) connected to the central drive shaft (4) by means of a second pair of connecting rods (7) (7′). Given that the first piston (5) and the second piston (5′) are of equal construction, only the former will be described. As can be seen in FIGS. 1, 3 and 4, the first piston (5) comprises a head (5A), a skirt (5B), a coupling (5C) arranged at the end of said skirt (5B) and a bolt (5D) configured to couple in a rotational way the first pair of connecting rods (6) (6′) to said piston (5). Components such as scraper rings, retention rings, retainers, etc. have been omitted so as to simplify the description, however, a person skilled in the art will know that the same are essential to the normal functioning of the internal combustion engine (1).

As can be seen in FIG. 1, the first piston (5) is connected to the central drive shaft (4) by means of a first pair of connecting rods (6) (6′) and the second piston (5′) by means of a second pair of connecting rods (7) (7′). The connecting rods that make up the pairs of connecting rods (6) (6′) (7) (7′) are equal in construction, and therefore only one of them will be described. In FIG. 5 one can see the second connecting rod (6′) which comprises a piston connection end (6′A), which is configured to receive the bolt (5D) of the piston (5), and central shaft connection end (6′B), in which the eccentric mechanism (8′) is provided. The connecting rods function in pairs of connecting rods (6) (6′), each one located on one side of the respective piston thereof, first piston (5), for dynamically balancing said piston. The connecting rods are in charge of transmitting and converting the reciprocating motion of the pistons (5) (5′) caused by combustion based on the eccentric mechanism (8) (8′) into circular motion of torque in the drive shaft (4). In reference to FIG. 5, one can see that the eccentric mechanism (8′) is made up of a fixed part (8′A) and a rotational part (8′B) configured to rotate with respect to the fixed part (8′A); wherein the rotational part (8′B) comprises a connecting part (8′C) configured to connect to the connecting portion (4C) of the central drive shaft (4). In the embodiment shown in FIG. 5, the portions of the connecting portions (4B) (4C) of the central drive shaft (4) are shown as flat surfaces that lock into flat surfaces (not shown) provided in the connecting part (8′C), such that the central drive shaft (4) does not rotate with respect to the connecting part (8′C). As is well known, the distance between the center of rotation of the rotating part (8′B) and the center of rotation of the central drive shaft (4), which is the same axial geometric central axis (C1), causes a reciprocating motion that is reflected in the piston connection end (6′A) of the connecting rod (6′); in a reciprocal way, a reciprocating motion of the piston connection end (6′A) will generate a circular motion in the central drive shaft (4) around the axial geometric central axis (C1) by means of an eccentric mechanism (8′), which is the operating principle of the combustion engine (1) of the present invention.

In preferred embodiments, the piston stroke (5) is equal to or less than the diameter of the same, and therefore the engine is configured as a square or super-square engine.

As can be seen in FIG. 3, the internal combustion engine comprises at least one intake manifold pipe (10) in connection with the intake port (3E) of the central body (3) and at least one exhaust manifold pipe (11) in connection with the exhaust port (3F) of the central body (3). As was previously mentioned, the intake valve (12) is operatively linked to the intake port (3E) and is configured to control the intake of gases from the intake manifold pipe (10) to the intake port (3E), while the exhaust valve (10) is operatively linked to the exhaust port (3F) and is configured to control the release of gases that are the product of combustion from the exhaust port (3F) to the exhaust manifold pipe (11).

As can be seen in FIGS. 1 and 3, to be able to support the internal combustion engine (1), a support cage (15) is arranged configured to support the internal combustion engine as a whole based on the fastening of the first cylinder (2) and the second cylinder (2′). The support cage (15) comprises at least first cylinder supports (15A) (15A′) configured to hold the first cylinder (5), second cylinder supports (15B) (15B′) configured to hold the second cylinder (5′), cross-members (15C) (15C′) configured to hold the first cylinder supports (15A) (15A′) and the second cylinder supports (15B) (15B′) butting against the protrusions (2A) (2′A) of the first cylinder (2) and of the second cylinder (2′A) such that said first (5) and second cylinders (5′) are firmly secured to the central body (3). To diametrically secure the first cylinder supports (15A) (15A′) to the first cylinder (2), the cage comprises first outer braces (15D). Similarly, the support cage (15) comprises second outer braces (15D′) configured for diametrically securing the second cylinder (2′). When all of the elements of the support cage (15) are joined, the assembly of the internal combustion engine (1) of the present invention is formed.

Up to now the invention has been described as an opposed-piston internal combustion engine (1) which has a single body (3) and two cylinders (5) (5′), however based on the requirements of the motor it is possible to put several central bodies with the respective pair of cylinders, pistons and connecting rods thereof, extending and sharing a central shaft (3).

Exemplifying this in FIG. 6, an internal combustion engine (100) has been shown with four central bodies, eight cylinders, eight pistons and sixteen connecting rods connected to a single central drive shaft (40). This and other longer or shorter configurations are possible thanks to the self-balancing configuration of the combustion engine with respect to the central shaft.

1. An internal combustion engine (1) comprising at least an axial geometric cylinder axis (A1) and an axial geometric central axis (C1), said geometric axes being orthogonal to one another, a first cylinder (2) coaxial to the cylinder axis (A1), a second cylinder (2′) coaxial to the cylinder axis (A1) provided opposite at least said first cylinder (2), said internal combustion engine characterized in that it comprises:
a central body (3) comprising a hole (3A) that passes through said central body (3A) and which is axially aligned with the axial geometric central axis (C1), a first cylindrical recess (3B) configured to couple the first cylinder (2) and a second cylindrical recess (3B′) configured to couple the second cylinder (2′);
a central drive shaft (4) arranged in the hole (3A) of the central body (3);
a first piston (5) provided in the first cylinder (2), said first piston (5) being connected to the central drive shaft (4) by means of a first pair of connecting rods (6) (6′); and
a second piston (5′) provided in the second cylinder (2′), opposite the first piston (5), said second piston (5′) being connected to the central drive shaft (4) by means of a second pair of connecting rods (7) (7′);
said central body (3) comprising:
an intake channel (3C) that extends in a direction parallel to the axial cylinder axis (A1) and which passes through the central body (3);
an exhaust channel (3D) that extends in a direction parallel to the axial cylinder axis (A1) and which passes through the central body (3);
an intake port (3E) in fluid connection with the intake channel (3C); and
an exhaust port (3F) in fluid connection with the exhaust channel (3D).

2. The internal combustion engine according to claim 1, characterized in that each one of the connecting rods of the first pair of connecting rods (6) (6′) and of the second pair of connecting rods (7) (7′) comprises eccentric mechanisms (8) (8′) (9) (9′) that rotationally connect said first pair of connecting rods (6) (6′) and second pair of connecting rods (7) (7′) to the central drive shaft (4), wherein said eccentric mechanisms (8) (8′) (9) (9′) are configured to convert the linear motion of the first piston (5) and the second piston (5′) into circular motion in the central drive shaft (4).

3. The internal combustion engine according to claim 2, characterized in that the central drive shaft (4) comprises at least a smooth cylindrical portion (4A) configured to be in the hole (3A) of the central body, and at least two connecting portions (4B) (4C) configured to connect to the eccentric mechanisms (8) (8′) (9) (9′) and to receive torque from said eccentric mechanisms (8) (8′) (9) (9′).

4. The internal combustion engine according to claim 1, characterized in that it comprises:
at least one intake manifold pipe (10) in connection with the intake port (3E) of the central body (3);
at least one exhaust manifold pipe (11) in connection with the exhaust port (3F) of the central body (3);
at least one intake valve (12) operatively linked to the intake port (3E) and configured for controlling gas intake from the intake manifold pipe (10) to the intake port (3E); and
at least one exhaust valve (13) operatively linked to the exhaust port (3F) and configured for controlling the release of gases from the exhaust port (3F) to the exhaust manifold pipe (11).

5. The internal combustion engine according to claim 1, characterized in that it comprises:
a support cage (15) configured to support the internal combustion engine as a whole based on the fastening of the first cylinder (2) and the second cylinder (2′).
